(19) United States
(12) Patent Application Publication
(10) Pub. No.: US 2008/0254983 A1
(43) Pub. Date: Oct. 16, 2008

(54) Herbicide Composition

(75) Inventors: Aristos Panayi, Victoria (AU); Chad Richard Ord Sayer, Victoria (AU); Andrew John Wells, Victoria (AU)

Correspondence Address: NIXON PEABODY LLP - PATENT GROUP, 1100 CLINTON SQUARE, ROCHESTER, NY, 14604, US

(73) Assignee: NUFARM AUSTRALIA LIMITED, Laverton North, Victoria (AU)

(21) Appl. No.: 12/066,803

(22) PCT Filed: Sep. 15, 2006
(86) PCT No.: PCT/AU06/01355

§ 371 Date: May 6, 2008

Related U.S. Application Data
(60) Provisional application No. 60/786,365, filed on Mar. 28, 2006.

(30) Foreign Application Priority Data
Sep. 16, 2005 (AU) 2005905130
Sep. 16, 2005 (AU) 2005905131

(51) Int. Cl. A01N 57/10; A01N 33/18; A01P 13/00

(52) U.S. Cl. 504/127; 504/347

(57) ABSTRACT

The invention relates to an herbicidal composition comprising from about 30 to about 70% by weight of the composition, of at least one dinitroaniline herbicide; an organic solvent having a flash point greater than 60.5° C.; and acetophenone in amount in the range from 5-25% by weight. The invention also relates to a method of controlling weeds using the composition.

This application claims the benefit of Australian Provisional Application 2005905130 (16 Sep. 2005), Australian Provisional Application 2005905131 (16 Sep. 2005) and U.S. Provisional Application No. 60/8786,365 (28 Mar. 2006), the contents of which are incorporated by reference.

### FIELD OF THE INVENTION

The present invention relates to stable compositions comprising dinitroaniline herbicides, methods for the manufacture of such compositions and methods of controlling plant growth using the dinitroaniline herbicidal compositions. The invention also relates to mixtures of at least one dinitroaniline herbicide with another herbicide, to methods for the preparation of herbicidal compositions and to methods for controlling weeds using the dinitroaniline compositions or mixtures.

### BACKGROUND

Dinitroanilines (more specifically 2,6-dinitroanilines) are a group of herbicides used to control many grasses and broadleaf weeds. The dinitroanilines are most commonly used as pre-emergent herbicides and are incorporated in soil to control weeds in many important crops such as soybean, cotton, tobacco, tomatoes, cereals, canola, pulses and legume crops.

Dinitroanilines are of general formula I

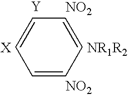

wherein

X is selected from lower alkyl, halogenated lower alkyl, lower alkyl sulfonyl and amino sulfonyl;

Y is hydrogen or lower alkyl

R₁ is hydrogen or lower alkyl: and

R₂ is lower alkyl, lower alkenyl or halogenated lower alkyl.

The lower alkyl/alkenyl fragments are typically C₁ to C₄ alkyl/C₂ to C₄ alkenyl.

Dinitroanilines may be formulated as concentrates for dilution with water at the time of use, for example in a spray tank. In order to minimize solvent use and transport cost it is desirable to use a concentrated solution of dinitroanilines which can be diluted prior to use. Concentrated solutions of dinitroaniline are generally not physically stable as they tend to crystallize, particularly at low temperatures. Commercial concentrate formulations of dinitroanilines such as trifluralin generally have concentrations of about 40-50% w/w for trifluralin and 30-45% for pendimethalin.

Attempts have been made to stabilize dinitroanilines using different solvents but often the solvents required such as toluene and xylene are highly flammable and would require special facilities to be used to meet safety requirements for highly flammable solvents. Accordingly some of the proposals for concentrates add significantly to the cost and risks associated with transport and storage.

For many herbicides it is the practice to incorporate fertilizer in the diluted compositions prepared from herbicidal concentrates in a spray tank prior to application. In this process (often called tank mixing) the dinitroanilines have been found to be incompatible with fertilizers. This incompatibility may be due to a physical or chemical incompatibility between the compounds and can result in the formation of mixtures and suspensions that clog up spray systems, contribute to disposal costs and lead to poor weed control. As compositions containing a liquid nitrogen fertilizer and dinitroanilines are often not homogeneous mixtures, they typically require constant and vigorous agitation in order to ensure adequate mixing of the fertilizer and herbicide prior to use.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of this application.

### SUMMARY

We have now found that in the presence particular amounts of acetophenone cosolvent herbicidal concentrates containing high concentrations of nitroanilines are relatively stable in less flammable organic solvents even at low temperatures.

In one aspect, the present invention provides a herbicidal composition comprising:
(i) from about 30 to about 70% by weight of the composition, of at least one dinitroaniline;
(ii) an organic solvent having a flash point of greater than 60.5° C.; and
(iii) acetophenone in amount in the range of from 5 to 25% by weight.

Generally, we have found that by using acetophenone the stability is improved allowing the composition to be formulated with lower flammability solvents so that the compositions can be more safely stored and/or transported and stored with reduced risk. The composition will typically comprise at least 5% by weight acetophenone. The amount of acetophenone generally should not exceed 25%. Preferably, the herbicidal concentrate composition includes from about 5 to about 20% by weight of the composition of acetophenone. Generally the acetophenone content for obtaining optimal stability will be no more than 15% by weight acetophenone and more preferably no more than 13% by weight acetophenone. Generally the optimum stability is obtained with at least 7% by weight acetophenone and more preferably at least 10% by weight acetophenone.

The composition may contain one or more dinitroanilines but the total dinitroaniline content is in the range of 30 to 70%, preferably from 37 to 65%, more preferably 40 to 60% and most preferably from about 40 to 50% by weight.

In a preferred embodiment, the composition includes from about 45 to about 65%, more preferably from about 50 to about 60% by weight of the composition, of dinitroaniline herbicide component. The one or more dinitroanilines are preferably selected from the group consisting of trifluralin, pendimethalin and ethalfluralin. More preferably the composition will include at least 50% by weight of the dinitroaniline component as trifluralin and optionally one or both of pendimethalin and ethalfluralin. These compounds are of formula I as follows:

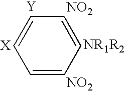

| Name | X | Y | R₁ | R₂ |
|---|---|---|---|---|
| trifluralin | CF₃ | H | C₃H₇ | C₃H₇ |
| pendimethalin | CH₃ | H | C₂H₅ | (C₂H₅)₂CH |
| ethalfluralin | CF₃ | H | C₂H₅ | CH₂═C(CH₃)CH₂ |

The herbicidal composition of the present invention may and preferably will include a surfactant. While a range of surfactants selected from the group consisting of nonionic, anionic, cationic and amphoteric surfactants may be used it is particularly preferred, for reasons we will discuss, that the surfactant comprise a phosphate ester surfactant such as a phosphorylated alcohol ethoxylate, phosphorylated alkyl phenol or phosphorylated sugar alcohol surfactant.

We have found that by formulating the dinitroaniline concentrate using such a phosphate ester surfactant the concentrate has added stability and is rendered more compatible with fertilizer such as urea-ammonium nitrate on dilution prior to use.

The composition of the invention is relatively stable even at low temperature. In a preferred embodiment, the composition does not give rise to crystalline precipitates for at least 48 hours upon storage at 0° C. and preferably does not give rise to crystalline precipitates for at least 72 hours and most preferably at least 7 days.

The herbicidal composition of the present invention is preferably an emulsifiable concentrate. The composition is preferably a solution which on dilution with water forms an emulsion of the organic phase in water which is sufficiently stable to allow application of the diluted composition to the site of use. It is particularly preferred that the composition comprise at least one emulsifier adapted to provide an oil-in-water emulsion on dilution of the concentrate with water prior to use. The phosphate ester surfactant may be or may contribute to the oil-in-water emulsifier component but it is particularly preferred that the composition of the invention contain an emulsifier selected from the group consisting of nonionic emulsifiers and in particular the preferred non ionic oil-in-water emulsifier comprises at least one selected from the group consisting of fatty alcohol ethoxylates, alkylamine ethoxylates, alkyl polysaccharides, sugar alcohol ester ethoxylates and alkylphenol ethoxylates. In order that the composition rapidly and effectively forms an oil in water emulsion it is also preferred that the composition contains a alkylaryl sulfonate surfactant such as dodecyl benzene sulfonate (e.g. calcium dodecyl benzene sulfonate). When used the alkylaryl sulfonate is preferably present in an amount of from 0.1 to 5% by weight of the composition.

The composition of the invention comprises an organic solvent having a flash point of at least 60.5° C. The organic solvent preferably comprises at least one hydrocarbon selected from alkyl substituted aromatics such as mono-, di- and trialkyl benzenes and alkyl naphthalenes. A person skilled in the art will readily be able to formulate suitable solvents and combinations to provide suitable solvent components on the basis of the teaching herein and widely reported flash point information. For example C₉ alkylbenzene is reported to have a flash point of 420 whereas C₁₀ alkylbenzene is reported to have a flash point of 66° C. A preferred co-solvent is a mixture of C₈-C₁₂ di- and trialkyl benzenes, commercially available from Exxon Mobil as Solvesso 150™ and Solvesso 200.

In a further aspect, the present invention also provides a process for preparing a herbicidal composition comprising combining from about 30 to about 70% by weight of the composition of a dinitroaniline component (preferably comprising at least one dinitro aniline herbicide selected from the group consisting of trifluralin, pendimethalin and ethalfluralin); from 5 to 25% (preferably from 5 to 20%, more preferably from 5 to 17% and still more preferably from 8 to 15% and most preferably 8 to 10% by weight) of acetophenone and an organic solvent of flash point of at least 60.5° C.

In yet another aspect, the present invention provides a method of controlling weeds comprising combining the above described dinitroaniline composition with an aqueous fertilizer component preferably comprising a UAN fertilizer (optionally with additional water) and applying a herbicidal effective amount of the diluted herbicidal composition the dilution of water and combination may involve one or more steps or be conducted simultaneously. Generally the UAN fertilizer will be in a liquid form. The composition is preferably applied to soil in an amount effective for providing pre-emergent herbicidal activity.

This invention also allows the combination of dinitroanilines with other herbicides at concentrations that have not in many cases hereto before been possible.

Indeed in some cases the composition allows the combination of herbicide which have not been previously reported in single formulations. While a range of herbicides may be used in the dinitroaniline formulation a particularly preferred combination comprises at least one dinitroaniline herbicide and cinmethylin.

The composition is preferably in the form of a concentrate and most preferably will comprise at least 30% by weight of the total concentrate of the dinitroaniline component.

The weight ratio of dinitroaniline to other herbicide is preferably in the range of from 99:1 to 1:1.5 and more preferably from 10:1 to 1:1.

### DETAILED DESCRIPTION

The present invention provides a herbicidal composition comprising:
(iv) from about 30 to about 70% by weight of the composition, of at least one dinitroaniline;
(v) an organic solvent having a flash point of greater than 60.5° C.; and
(vi) acetophenone in amount in the range of from 5 to 25% by weight.

Herbicidal compositions of the invention that include one or more dinitroanilines such as trifluralin typically do not give rise to the formation of crystalline precipitates for a period of at least 48 hours, preferably at least 72 hours and still more preferably at least 7 days at a temperature of 0° C.

Acetophenone is an aromatic ketone compound that acts as a cosolvent with the organic solvent. Acetophenone assists in stabilizing the herbicidal composition of the present invention by preventing the formation of crystalline precipitates in the composition during storage of the composition. Surprisingly we have found that the effect of acetophenone in enhancing stability is most pronounced when the concentration of the acetophenone is relatively low. A concentration at or approaching from 8 to 12% is particularly preferred in many cases. Thus, for example, we have found that the stability of compositions of about 55% trifluralin in di- and tri-alkyl benzenes as a solvent (where the solvent has a flash point of at least 60.5° C.) is more stable when 10% acetophenone is present rather than 20% acetophenone. The amount of acetophenone which is optimal may vary for different dinitroanilines and mixtures thereof however generally the concentration of acetophenone is in the range of from 5 to 20% by weight and preferably from 8 to 17% by weight.

The concentration of acetophenone that may be used in the composition of the present invention may be any amount in the range 5 to 25% effective to prevent the formation of crystalline precipitates upon storage of the composition for at least 48 hours. If crystalline precipitates are to form in the herbicidal composition, such precipitates are most likely to occur within the first 48 hours of storage.

The dinitroaniline concentrate may optionally contain one or more surfactants which act as wetting, emulsifying and/or dispersing agents to aid in the preparation of the dilute herbicidal composition or in the application or penetration of the composition into the soil. One or more liquid carriers may be used in the preparation of the herbicidal composition. Examples of optional additional liquid carriers include water; mineral oil fractions such as, for example, kerosene, solvent naphtha, petroleum, coal tar oils and aromatic petroleum fractions; aliphatic, cycloaliphatic and aromatic hydrocarbons such as, for example, paraffin, cyclohexane, tetrahydronaphthalene and alkylated naphthalenes; alcohols such as, for example, methanol, ethanol, propanol, isopropanol, butanol, cyclohexanol and propylene glycol; ketones such as, for example, cyclohexanone and isophorone; and strongly polar organic solvents such as, for example, dimethylformamide, dimethylsulfoxide, N-methylpyrrolidone and sulfolane. The alkylated aromatics will preferably comprise at least 30% more preferably 50% by weight of the solvent, still more preferably at least 70% and most preferably at least 80% by weight of the solvent component including the acetophenone.

An example of a suitable hydrocarbon liquid carrier is a long chain alkylbenzene composition such as the C₉-C₁₀ di- and trialkylbenzenes available from Exxon Mobil as Solvesso 150™.

The herbicidal composition of the invention may and generally will also include a surfactant. The surfactant may assist in compatibilizing the components of the herbicidal composition and stabilizing the composition of the present invention through the formation of emulsion or dispersions. The surfactant may be any suitable surfactant, having regard to the solvent, diluent, the extent of dilution required for use of the concentrate and the period of physical stability required following dilution prior to use. The surfactant, when present, will typically constitute in the range from 0.5 to 20% by weight of the total composition and more preferably from 3 to 10%. The composition may and preferably will include two or more surfactants. The use of additional surfactants may assist in enhancing the stability of the composition.

The term surfactant is used in the broad sense to include materials which may be referred to as emulsifying agents, dispersing agents and wetting agents and the surfactant component may comprise one or more surfactants selected from the anionic, cationic, nonionic and amphoteric types.

Cationic surfactants include quaternary ammonium compounds, for example, the long chain alkylammonium salts such as cetyltrimethylammonium bromide. Anionic surfactants include soaps or the alkali metal, alkaline earth metal and ammonium salts of fatty acids; the alkali metal, alkaline earth metal and ammonium salts of ligninsulfonic acid; the alkali metal, alkaline earth metal and ammonium salts of arylsulfonic acids including the salts of naphthalenesulfonic acids such as butylnaphthalenesulfonic acid, the di- and tri-isopropylnaphthalenesulfonic acids, the salts of the condensation products of sulfonated naphthalene and naphthalene derivatives with formaldehyde, the salts of the condensation products of sulfonated naphthalene and naphthalene derivatives with phenol and formaldehyde, and the salts of alkylarylsulfonic acids such as dodecylbenzenesulfonic acid and their salt such as calcium dodecyl benzene sulfonate; the alkali metal, alkaline earth metal and ammonium salts of the long chain mono esters of sulfuric acid or alkylsulfates such as laurylsulfate and the mono esters of sulfuric acid with fatty alcohol glycol ethers. Nonionic surfactants include the condensation products of ethylene oxide with fatty alcohols such as oleyl alcohol and cetyl alcohol; the condensation products of ethylene oxide with phenols and alkylphenols such as isooctylphenol, octylphenol and nonylphenol; the condensation products of ethylene oxide with castor oil; the partial esters derived from long chain fatty acids and hexitol anhydrides, for example sorbitan monolaurate, and their condensation products with ethylene oxide; ethylene oxide/propylene oxide block copolymers; lauryl alcohol polyglycol ether acetal; the lecithins and phosphorylated surfactants such as phosphorylated ethylene oxide/propylene oxide block copolymer and ethyoxylated and phosphorylated stryryl substituted phenol.

The composition of the invention will typically include one or more surfactants for providing an oil-in-water emulsion on dilution with water prior to use. The preferred oil-in-water emulsifiers include nonionic emulsifiers comprising a polyalkylene oxide derivative.

Preferably, the surfactant includes phosphorylated alcohol ethoxylate which we have found is particularly useful in stabilizing the concentrate and also in stabilizing the diluted concentrate when admixed with a fertilizer such as UAN.

Examples of suitable phosphate ester surfactants include:
(i) alcohol phosphates such as alkyl mono and di-phosphates (eg. N-butyl mono/di-phosphate) and C₆ to C₁₀ alkyl phosphate esters;
(ii) alcohol ethoxylate phosphates such as C₈ to C₁₀ alcohol ethoxylate phosphate esters, tridecyl alcohol ethoxylate phosphate esters, C₁₀ to C₁₅ alcohol ethoxylate phosphate esters, butyl cellosolve phosphate esters, oleyl alcohol ethoxylate phosphate esters;
(iii) alkyl phenol ethoxylate phosphates such as nonylphenol ethoxylate phosphate ester and salts thereof and dinonylphenol ethoxylate phosphate ester;
(iv) aryl phosphate ethoxylate esters such as phenol ethoxylate phosphate esters; and
(v) alkyl amine phosphates such as triethylammonium phosphate.

The amount of surfactant used in the herbicidal composition will depend on the nature of the surfactant, any co-solvents and the desired dilution factor. A wide range of surfactants may be used and the skilled worker will readily be able to choose surfactants having regard to the advantages provided by the present invention described herein. In a preferred embodiment, the surfactant is preferably present in an amount of from about 0.5 to 20% and more preferably from about 3 to about 10% by weight of the composition. We have found that about 6% (w/w) is particularly useful in many cases.

In a preferred embodiment, the herbicidal composition of the present invention is used with a liquid nitrogen fertilizer. The dilution of the composition of the invention with water and a liquid nitrogen fertilizer prior to application advantageously allows a single composition to be formulated which enhances the herbicidal activity of the dinitroaniline component.

The presence of acetophenone and surfactant (particularly the phosphate ester surfactant) in the compositions of the present invention however, assists to compatibilise the fertilizer with the one or more dinitroanilines, resulting in a stable concentrate and diluted composition even in the presence of relatively high concentrations of dinitroanilines. Dinitroaniline herbicides have previously been found to be incompatible with or poorly compatible with fertilizers such as UAN. While attempts have been made to try and overcome the incompatibility by using additives at the time of dilution and combination with fertilizer, such strategies add complexity and inconvenience to use of concentrates in the field. The ability to use a concentrate composition which at least ameliorates the poor compatibility provides a significant advantage to farmers.

The fertilizer may comprise one or more of nitrogen, phosphorous, potassium sulfur and trace elements based fertilizers. The liquid nitrogenous fertilizer may be any suitable fertilizer and it would be appreciated by the person skilled in the art that the choice of fertilizer will often be dependent on the type of plant or crop to which the composition of the present invention is to be applied. Preferably, the liquid nitrogenous fertilizer is urea-ammonium nitrate (UAN) or urea-ammonium sulfate (UAS). The liquid nitrogen fertilizer may be added neat to the composition or it may be diluted with an appropriate solvent prior to its inclusion in the herbicidal composition of the invention. When the liquid nitrogen fertilizer is diluted, preferably the solvent is water.

The amount of liquid nitrogen fertilizer used in the diluted herbicidal composition may be any concentration that achieves the advantages of the present invention. It would be appreciated by the person skilled in the art that the desired concentration of liquid nitrogen fertilizer will be dependent upon the type of weed to be controlled and the application rate.

In a preferred embodiment, the liquid nitrogen fertilizer is mixed with the concentrate of the invention in an amount of from about 20% to 100% by weight of the dinitroaniline component of the concentrate composition.

Without being limited by theory, it is believed that the phosphate group of the phosphorylated surfactant may assist in stabilizing the concentrate and also interact with nitrogen in the liquid nitrogen fertilizer in the diluted composition to stabilize the herbicidal composition which is applied by spraying or other art recognized application methods. The surfactant may interact with the fertilizer through ionic or covalent bonds. The interaction enables the herbicidal composition comprising the liquid nitrogen fertilizer to remain as a stable solution or emulsion and minimizes unwanted separation of the components of the composition.

The ability to store the herbicidal composition for a sustained period of time is beneficial, as it allows the user to purchase a concentrated composition and store the composition until it is desired for use without fear of loss of efficacy over time. As a result, wastage of the composition and costs associated with the disposal of unused herbicide is minimized. Furthermore, as the herbicidal composition of the invention forms stable compositions, any risk associated with the clogging of equipment or incorrect dosage of the herbicide may be avoided.

The ability of the composition to remain stable at cold ambient temperatures is advantageous for use in countries that experience cold climates, such as in many parts of Europe, Asia and North America. As the compositions of the present invention resist the formation of crystallization particles even at cold storage, the useful lifetime of the herbicidal composition is greatly increased in such countries.

The compositions of the invention may comprise, in addition to dinitroanilines, one or more additional herbicides. For example, as hereinbefore indicated the compounds of the invention are in general substantially more effective against broad-leaved and grass weed species that are currently poorly controlled by dinitroaniline herbicides. As a result, in certain applications the herbicidal use of the compounds of the invention alone may not be sufficient to protect a crop. In yet a still further embodiment the invention provides a herbicidal composition additionally comprising at least one other herbicide.

The optional additional herbicide will generally be a herbicide having a complementary action. For example, one preferred class is of mixtures comprising a herbicide active weeds not adequately suppressed by the dinitroanilines. A second preferred class is of mixtures comprising a contact herbicide.

The composition of the invention may comprise one or more additional herbicides. Additional herbicides may be selected from:

amide herbicides such as allidochlor, beflubutamid, benzadox, benzipram, bromobutide, cafenstrole, CDEA, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid and tebutam;

anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil;

arylalanine herbicides such as benzoylprop, flampropand flamprop-M;

chloroacetanilide herbicides such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor and xylachlor;

sulfonanilide herbicides such as benzofluor, cloransulam, diclosulam, florasulam, flumetsulam, metosulam, perfluidone, pyrimisulfan and profluazol;

sulfonamide herbicides such as asulam, carbasulam, fenasulam, oryzalin, penoxsulam and pyroxsulam, see also sulfonylurea herbicides;

thioamide herbicides such as bencarbazone and chlorthiamid;

antibiotic herbicides such as bilanafos;

aromatic acid herbicides

benzoic acid herbicides such as chloramben, dicamba, 2,3,6-TBA and tricamba;

pyrimidinyloxybenzoic acid herbicides such as bispyribac and pyriminobac;

pyrimidinylthiobenzoic acid herbicides such as pyrithiobac;

phthalic acid herbicides such as chlorthal;

picolinic acid herbicides such as aminopyralid, clopyralid and picloram;

quinolinecarboxylic acid herbicides such as quinclorac and quinmerac;

arsenical herbicides such as cacodylic acid, CMA, DSMA, hexaflurate, MAA, MAMA, MSMA, potassium arsenite and sodium arsenite;

benzoylcyclohexanedione herbicides such as mesotrione, sulcotrione, tefuryltrione and tembotrione;

benzofuranyl alkylsulfonate herbicides such as benfuresate and ethofumesate;

carbamate herbicides such as asulam, carboxazole, chlorprocarb, dichlormate, fenasulam, karbutilate and terbucarb;

carbanilate herbicides such as barban, BCPC, carbasulam, carbetamide, CEPC, chlorbufam, chlorpropham, CPPC, desmedipham, phenisopham, phenmedipham, phenmedipham-ethyl, propham and swep;

cyclohexene oxime herbicides such as alloxydim, butroxydim, clethodim, cloproxydim, cycloxydim, profoxydim, sethoxydim, tepraloxydim and tralkoxydim;

cyclopropylisoxazole herbicides such as isoxachlortole and isoxaflutole;

dicarboximide herbicides such as benzfendizone, cinidon-ethyl, flumezin, flumiclorac, flumioxazin, and flumipropyn;

dinitrophenol herbicides such as dinofenate, dinoprop, dinosam, dinoseb, dinoterb, DNOC, etinofen and medinoterb;

diphenyl ether herbicides such as ethoxyfen;

nitrophenyl ether herbicides such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen;

dithiocarbamate herbicides such as dazomet and metam;

halogenated aliphatic herbicides such as alorac, chloropon, dalapon, flupropanate, hexachloroacetone, iodomethane, methyl bromide, monochloroacetic acid, SMA and TCA;

imidazolinone herbicides such as imazamethabenz, imazamox, imazapic, imazapyr, imazaquin and imazethapyr;

inorganic herbicides such as ammonium sulfamate, borax, calcium, chlorate, copper sulfate, ferrous sulfate, potassium azide, potassium, yanate, sodium azide, sodium chlorate and sulfuric acid;

nitrile herbicides such as bromobonil, bromoxynil, chloroxynilm, iodobonil, ioxynil and pyraclonil;

organophosphorus herbicides such as amiprofos-methyl, anilofos, bensulide, bilanafos, butamifos, 2,4-DEP, DMPA, EBEP, fosamine, glufosinate, glyphosate, and piperophos;

oxadiazolone herbicides such as dimefuron, methazole, oxadiargyl and oxadiazon;

phenoxy herbicides such as bromofenoxim, clomeprop, 2,4-DEB, 2,4-DEP, difenopenten, disul, erbon, etnipromid, fenteracol and trifopsime;

phenoxyacetic herbicides such as 4-CPA, 2,4-D, 3,4-DA, MCPA, MCPA-thioethyl and 2,4,5-T;

phenoxybutyric herbicides such as 4-CPB, 2,4-DB, 3,4-DB, MCPB and 2,4,5-TB;

phenoxypropionic herbicides such as cloprop, 4-CPP, dichlorprop, dichlorprop-P, 3,4-DP, fenoprop, mecopropand mecoprop-P;

aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop;

phenylenediamine herbicides such as dinitramine, and prodiamine;

phenyl pyrazolyl ketone herbicides such as benzofenap, pyrasulfotole, pyrazolynate, pyrazoxyfen and topramezone;

pyrazolylphenyl herbicides such as fluazolate, nipyraclofen and pyraflufen;

pyridazine herbicides such as credazine, pyridafol and pyridate;

pyridazinone herbicides such as brompyrazon, chloridazon, dimidazon, flufenpyr, metflurazon, norflurazon, oxapyrazon and pydanon;

pyridine herbicides such as aminopyralid, cliodinate, clopyralid, dithiopyr, fluoroxypyr, haloxydine, picloram, picolinafen, pyriclor, thiazopyr and triclopyr;

pyrimidinediamine herbicides such as iprymidam and tioclorim;

quaternary ammonium herbicides such as cyperquat, diethamquat, difenzoquat, diquat, morfamquat and paraquat;

thiocarbamate herbicides such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vernolate;

thiocarbonate herbicides such as dimexano, EXD, proxan and eptam (EPTC);

thiourea herbicides such as methiuron;

triazine herbicides such as dipropetryn; triaziflam and trihydroxytriazine;

chlorotriazine herbicides such as atrazine; chlorazine, cyanazine, cyprazine, eglinazine, ipazine, mesoprazine, procyazine, proglinazine, propazine, sebuthylazine, simazine, terbuthylazine and trietazine;

methoxytriazine herbicides such as atraton, methometon, prometon, secbumeton, simeton and terbumeton;

methylthiotriazine herbicides such as ametryn, aziprotryne, cyanatryn, desmetryn, dimethametryn, methoprotryne, prometryn, simetryn and terbutryn;

triazinone herbicides such as ametridione, amibuzin, hexazinone, isomethiozin, metamitron and metribuzin;

triazole herbicides such as amitrole, cafenstrole, epronaz and flupoxam;

triazolone herbicides such as amicarbazone, bencarbazone, carfentrazone, flucarbazone, propoxycarbazone and sulfentrazone;

triazolopyrimidine herbicides such as cloransulam, diclosulam, florasulam, flumetsulam, metosulam and penoxsulam;

uracil herbicides such as butafenacil, bromacil, flupropacil, isocil, lenacil and terbacil;

urea herbicides such as benzthiazuron, cumyluron, cycluron, dichloralurea, diflufenzopyr, isonoruron, isouron, methabenzthiazuron, monisouron and noruron;

phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron and thidiazuron;

sulfonylurea herbicides including:

pyrimidinylsulfonylurea herbicides such as amidosulfuron; azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron and trifloxysulfuron;

triazinylsulfonylurea herbicides such as chlorsulfuron, cinosulfuron, ethametsulfuron, iodosulfuron, metsulfuron, prosulfuron, thifensulfuron, triasulfuron, tribenuron, triflusulfuron and tritosulfuron; and

thiadiazolylurea herbicides such as buthiuron, ethidimuron, tebuthiuron, thiazafluoron and thidiazuron; and

unclassified herbicides such as KIH-485, acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate endothal, fluoromidine, fluridone, fluorochloridone, flurtamone, fluthiacet, indanofan, methyl isothiocyanate, OCH, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan and tritac.

Examples of referred complementary herbicides include:

A. benzo-2,1,3-thiadiazin-4-one-2,2-dioxides such as 3-isopropylbenzo-2,1,3-thiadiazin-4-one-2,2-dioxide (common name bentazon);

B. hormone herbicides and in particular the phenoxyalkanoic acids such as 4-chloro-2-methylphenoxy acetic acid (common name MCPA), 2-(2,4-dichlorophenoxy)propionic acid (common name dichlorprop), 2,4,5-trichlorophenoxyacetic acid (common name 2,4,5-T), 4-(4-chloro-2-methylphenoxy)butyric acid (common name MCPB), 2,4-dichlorophenoxyacetic acid (common name 2,4-D), 4-(2,4-dichlorophenoxy)butyric acid (common name 2,4-DB), 2-(4-chloro-2-methylphenoxy)propionic acid (common name mecoprop), and their derivatives (eg salts, esters, amides and the like);

C. 3-[4-(4-halophenoxy)phenyl]-1,1-dialkylureas such as 3-[4-(4-chlorophenoxy)phenyl]-1,1-dimethylurea (common name chloroxuron);

D. dinitrophenols and their derivatives (eg acetates) such as 2-methyl-4,6-dinitrophenol (common name DNOC), 2-tertiarybutyl-4,6-dinitrophenol (common name dinoterb), 2-secondarybutyl-4,6-dinitrophenol (common name dinoseb) and its ester dinoseb acetate;

E. phenylurea herbicides such as N′-(3,4-dichlorophenyl)-N,N-dimethylurea (common name diuron) and N,N-dimethyl-N′-[3-(trifluoromethyl)phenyl]urea (common name fluometuron);

F. Sulfonyl urea herbicides such as chlorsulfuron. Metsulfuron, metsulfuron methyl and metsulfuron ethyl.

G. phenylcarbamoyloxyphenylcarbamates such as 3-[(methoxycarbonyl)amino]phenyl(3-methylphenyl)carbamate (common name phenmedipham) and 3-[(ethoxycarbonyl)amino]phenyl phenylcarbamate (common name desmedipham);

H. 2-phenylpyridazin-3-ones such as 5-amino-4-chloro-2-phenylpyridazin-3-one (common name pyrazon, chloridazon);

I. uracil herbicides such as 3-cyclohexyl-5,6-trimethyleneuracil (common name lenacil), 5-bromo-3-sec-butyl-6-methyluracil (common name bromacil) and 3-tert-buty-5-chloro-6-methyluracil (common name terbacil);

J. triazine herbicides such as 2-chloro-4-ethylamino-6-(iso-propylamino)-1,3,5-triazine (common name atrazine), 2-chloro-4,6-di(ethylamino)-1,3,5-triazine (common name simazine) and 2-azido-4-(iso-propylamino)-6-methylthio-1,3,5-triazine (common name aziproptryne);

K. 1-alkoxy-2-alkyl-3-phenylurea herbicides such as 3-(3,4-dichlorophenyl)-1-methoxy-1-methylurea (common name linuron), 3-(4-chlorophenyl)-1-methoxy-1-methylurea (common name monolinuron) and 3-(4-bromo-4-chlorophenyl)-1-methoxy-1-methylurea (common name chlorobromuron), 3-(4(isopropylphenyl)-1,1-dimethylurea (common name isoproturon), 3-(3-chloro-ptolyl)-1,1 dimethylurea (common name chlorotoluron)

L. thiolcarbamate herbicides such as S-propyl dipropylthiocarbamate (common name verolate), 3-trichloroallyl di-isopropyl thiocarbamate (common name triallate), prosulfocarb;

M. 1,2,4-triazin-5-one herbicides such as 4-amino-4,5-dihydro-3-methyl-6-phenyl-1,2,4-triazine-5-one (common name metamitron) and 4-amino-6-tert-butyl-4,5-dihydro-3-methylthio-1,3,4-triazin-5-one (common name metribuzin);

N. benzoic acid herbicides such as 2,3,6-trichlorobenzoic acid (common name 2,3,6-TBA), 3,6-dichloro-2-methoxybenzoic acid (common name dicamba) and 3-amino-2,5-dichlorobenzoic acid (common name chloramben).

O. anilide herbicides such as N-butoxymethyl-.alpha.-chloro-2′,6′-diethylacetanilide (common name butachlor), the corresponding N-methoxy compound (common name alachlor), the corresponding N-iso-propyl compound (common name propachlor) and 3′,4′-dichloropropionanilide (common name propanil), 2-chloro-N-ethoxymethyl-6-ethylaceto-o-toluidide (common name acetochlor), 2-chloro-6-ethyl-N-(2-methoxy-1-methylethyl)aceto-toluidide (common name metolachlor);

P. dihalobenzonitrile herbicides such as 2,6-dichlorobenzonitrile (common name dichlobenil), 3,5-dibromo-4-hydroxybenzonitrile (common name bromoxynil) and 3,5-diiodo-4-hydroxybenzonitrile (common name ioxynil).

Q. haloalkanoic herbicides such as 2,2-dichloropropionic acid (common name dalapon), trichloroacetic acid (common name TCA) and salts thereof;

R. diphenylether herbicides such as 4-nitrophenyl 2-nitro-4-trifluoromethylphenyl ether (common name fluorodifen), methyl 5-(2,4-dichlorophenoxy)-2-nitrobenzoate (common name bifenox), 2-nitro-5-(2-chloro-4-trifluoromethylphenoxy)benzoic acid and 2-chloro-4-trifluoromethylphenyl 3-ethoxy-4-nitrophenyl ether;

S. N-(heteroarylaminocarbonyl)benzenesulfonamides such as 2-chloro-N-[(4-methoxy-6-methyl-1,3,5-triazin-2-yl)aminocarbonyl]benzenesulfonamide (commonly known as DPX 4189); and

T. miscellaneous herbicides including N,N-dimethyldiphenylacetamide (common name diphenamid), N-(1-naphthyl)phthalamic acid (common name naptalam), 3-amino-1,2,4-triazole and terpenoid herbicides such as cinmethylin.

Examples of useful contact herbicides include:

U. bipyridylium herbicides such as those in which the active entity is the 1,1′-dimethyl-4,4′-dipyridylium ion (common name paraquat) and those in which the active entity is the 1,1′-ethylene-2,2′-dipyridylium ion (common name diquat);

V. organoarsenical herbicides such as monosodium methanearsonate (common name MSMA); and

W. amino acid herbicides such as N-(phosphonomethyl)glycine (common name glyphosate) and its salts and esters.

The most preferred herbicides for use in the dinitroaniline herbicidal composition are selected from nitrile herbicides, amide herbicides, cinmethylin.

In one embodiment, the composition contains an additional herbicide which is water-soluble and which may be present in the aqueous phase or which becomes suspended or dissolved in the aqueous phase on dilution.

The herbicidal composition of the present invention may also include other additives. Suitable additives include for example, fragrances, colours, preservatives, buffers and the like. Such additives generally do not affect the efficacy of the active components of the composition. Rather, the presence of the additives, if any, may assist in providing a more aesthetically pleasing herbicidal composition or further improve the shelf-life of the composition.

In a particularly preferred embodiment the invention provides a composition comprising at least one dinitroaniline herbicide (such as trifluralin, pendimethalin, ethalfluralin and mixtures of at least two thereof) and cinmethylin.

The mixture concentrate will typically contain an inorganic solvent having a flash point of greater than 60.5° C. and acetophenone in the range of from 5 to 25% by weight of the total composition.

The preferred ranges of the components in the mixture of herbicides is in accordance with the above described contents of organic solvent and acetophenone.

The compositions of the present invention may be prepared in any suitable manner, and appropriate formulation techniques would be apparent to the person skilled in the art.

The herbicidal composition of the invention may also be used in a number of environments. These include the industrial and domestic environment. Industrial environments include for example, farms, market gardens and other commercial gardens, while the domestic environment includes home gardens and the like.

The concentrate composition of the invention is preferably diluted with water prior to use. The water diluted liquid composition is suitable for application by spraying, atomizing or watering. Such diluted compositions are generally prepared by mixing concentrated compositions with water to a suitable dilution dependant on the application rate and weed to be controlled. Aqueous dispersion or emulsions may also be prepared from the concentrated compositions containing surfactants by mixing the concentrated compositions with water and optionally adjuvants such as wetters, spreaders, stickers or the like. The concentrates are usually required to withstand storage for prolonged periods and after such storage to be capable of dilution to form liquid, preferably aqueous, preparations which remain homogeneous for a sufficient time to enable them to be applied by conventional spray equipment.

Emulsifiable concentrates are conveniently prepared by dissolving the dinitroaniline component in the organic solvent containing one or more surfactants. Thickening agents may also be included in the concentrates but they are not typically preferred. Suitable thickening agents include hydrophilic colloids such as, for example, poly(N-vinylpyrrolidone), sodium carboxymethylcellulose and the vegetable gums gum acacia and gum tragacanth; hydrated colloidal mineral silicates such as, for example, montmorillonite, beidellite, nontronite, hectorite, saponite, sauconite and bentonite; other cellulose derivatives; and poly(vinyl alcohol).

The diluted herbicidal concentrate of the invention may be directly applied to cereal crops or plants and do not generally require further processing or the addition of further adjuvants, diluents or additives in order to render it suitable for use. Such additives may however be used if desired.

In a further aspect, the present invention provides a method of controlling weeds comprising applying a herbicidally effective amount of a herbicidal composition or a ready to use herbicidal composition as described herein to an area of land comprising weeds and/or in which pre-emergent control is desired.

Liquid compositions of the invention may be applied by spraying, atomizing, watering, introduction into the irrigation water, or any other suitable means for broadcasting or spreading the liquid.

The rate of application of the compositions of the invention will depend on a number of factors including, for example, the compound chosen for use, the identity of the plants whose growth is to be inhibited, the formulations selected for use, whether the compound is to be applied for pre-emergent or post-emergent control and whether for foliage or root uptake. As a general guide, however, an application rate of from 0.01 to 20 kilograms of the dinitroaniline component per hectare is suitable while from 0.1 to 10.0 kilograms of the dinitroaniline component per hectare may be preferred.

The weeds may be in an area of land that also includes plants or crops. In this instance, the herbicidal composition may, depending on the crop, be applied to both the crops to take advantage of the selectivity of the dinitroanilines for certain plants to kill weeds without adversely effecting crops.

The compositions of the present invention may also be applied in any concentration and application rate that will enable it to control the growth, propagation and pre-emergence of weeds in an area of land. Preferably, the herbicidal composition is applied at an application rate of from about 0.5 to 12 litres of the concentrate per hectare.

### EXAMPLES

The present invention is described with reference to the following examples. It is to be understood that the examples are illustrative of and not limiting to the invention described herein.

### Example 1

### Comparison Herbicidal Composition Containing No Acetophenone

Two formulations having 480 and 500 g/L of trifluralin were prepared. For each formulation, ca. 6% of TERIC 305 (a phosphorylated alcohol ethoxylate in Solvesso 150™ was added. The trifluralin raw material used contains two surfactants—KEMMAT HF60 and Termul 1284. Trifluralin formulations containing 3% KEMMAT HF60 and 2% Termul 1284 provided the highest composition emulsion stability. Water emulsion stability studies with tap, standard C and 3 WHO water showed acceptable results, however cold storage stability studies showed significant crystal formation (8 and 16% for 480 and 500 g/L respectively). Storage stability trials were conducted by placing a sample of the composition in the fridge at 0° C. for 48 hours. After 48 hours the sample was seeded with trifluralin crystals prepared from the formulation matrix and placed back in the fridge for another 48 hours.

### Example 2

### Herbicidal Composition—10% Acetophenone

Two (480 and 500 g/L trifluralin) formulations were then prepared as in Example 1 but containing 20% (w/v) of acetophenone in place of a portion of the SOLVESSO 150 in order to improve solubility of the active (trifluralin). The emulsion stability in water was satisfactory. Cold storage stability showed no crystallisation in the case of 480 g/L formulation and 5.5% crystal formation for the 500 g/L trifluralin formulation. In order to minimise the cost of the proposed formulation as well as to reduce the amount of modifications to the existing trifluralin formulation, a reduction in the content of acetophenone was attempted whereby 10% w/v of the acetophenone was utilised. The new formulation is detailed in Table 1.

TABLE 1
Trifluralin formulations containing
DS 1560 (Teric 305) - composition

| Ingredient | Content, % (w/v) | Content, % (w/v) |
|---|---|---|
| Trifluralin | 480 (48% w/v) | 500 (50% w/v) |
| KEMMAT HF60 | 3 | 3 |
| Termul 1284 | 2 | 2 |
| Teric 305 (phosphorylated | 6 | 6 |
| alcohol ethoxylate surfactant) | | |
| Acetophenone | 10 | 10 |
| Solvesso 150 ™ | To the volume | To the volume |

Emulsion stability tests on both 480 and 500 g/L formulations showed an acceptable stability in Melbourne tap (20 ppm hardness), CIPAC standard C (500 ppm hardness) and 3 WHO waters (1000 ppm hardness) at 30° C.

These results show that the formulations containing 480 g/L and 500 g/L trifluralin provides a reasonably stable emulsion in tap, CIPAC STD C and 3WHO waters

Cold storage stability studies showed no visible crystallisation following standing at 0° C. for 48 hours. Only upon seeding the samples did crystal formation occur (5.4 and 8.0% for 480 and 500 g/L formulation respectively). As a comparison, crystal formation in the commercially available TriflurX composition typically comprises 5% after seeding. As a result, it is determined that the 480 g/L and 500 g/L trifluralin compositions of the invention have a satisfactory cold stability.

### Example 3

### Compatibility Studies

### Dilution Stability

Compatibility studies were performed on the Example 3 composition, which is shown below.

### (500 g/: Trifluralin) Example (Ex) 3 Composition

| Description | (g) |
|---|---|
| Trifluralin technical (96%) | 521 |
| KEMMAT HF60 | 50 |
| TERMUL 1284 | 28 |
| TERIC | 60 |
| Acetophenone | 100 |
| SOLVESSO 150 | To 1 L |

An amount of various herbicidal formulation(s) appropriate for the given application rate was added to either CIPAC STD C water (for comparative assessment) or to a neat aliquot of the commercially available urea-ammonium nitrate liquid fertilizer, Flexi-N, to make up to a total for 100 ml in a Crow Receiver. The crow receiver was stoppered and inverted 10 times. The type and degree of separation/precipitation at various times was then recorded over 2 hours at ambient temperature. If any phase separation had occurred after 2 hours, the crow receiver was then re-inverted ten times. The amount of phase separation at 30 seconds after re-inversion was then recorded. The results obtained when the composition are added to neat Flexi-N shown in Table 3, while the comparative results that are obtained when the composition is added to CIPAC STD C water is shown in Table 2.

### Results

TABLE 2
Compatibility in Standard CIPAC STD C water

| Formulation(s) | Observation | Comments |
|---|---|---|
| Ex 3 Composition | Compatible | Forms an emulsion which |
| (5 ml) | with | showed 11 ml of cream |
| CIPAC STD C water | agitation | formation after 2 h. Re- |
| (95 ml) | | emulsifies upon re-inversion |
| Ex 3 Composition | Compatible | Forms an emulsion which |
| (5 ml) | with | shows 7 ml of cream |
| R/up P. Max (10 ml) | agitation | formation after 2 h. Re- |
| CIPAC STD C water | | emulsifies after re-inversion |
| (85 ml) | | |

“Round Up Power Max” is a registered trademark of Monsanto and the product is distributed in Australia by Nufarm Australia Limited

“Flexi-N” is a registered trade mark of CSBP.

“Surpass” is a registered trademark of Nufarm Australia Limited

TABLE 3
Compatibility in Standard Flexi-N (neat)Liquid Fertiliser

| Formulation(s) | Observation | Comments |
|---|---|---|
| Ex 3 Composition | Compatible | Forms an emulsion which showed |
| (5 ml) | with | no cream formation after 2 h. |
| Flexi-N (95 ml) | agitation | |
| “Round-Up | Incompatible | Forms an emulsion which shows |
| Power Max” | | extreme flocculation after 2 h. |
| (10 ml) | | The solid re-suspends after the |
| Flexi-N (90 ml) | | re-inversion but does not re- |
| | | dissolve |
| Ex 3 Composition | Compatible | Forms an emulsion which shows |
| (5 ml | with | separation after 2 h into 7 ml |
| “Round-up Power | Agitation | of brown cream (top) and green |
| Max”) (10 ml) | | suspension containing solid. Re- |
| Flexi-N (85 ml) | | emulsifies after re-inversion. |
| Diuron 900 (3 g) | Incompatible | Does not form an emulsion even |
| Flexi-N to 100 ml | | after 30 inversions and vigorous |
| | | shaking (solid floats on the |
| | | top). 2 ml of solid and 4 ml of |
| | | cream after 2 h. Solid remains |
| | | upon re-inversion |

The above compatibility tests show Ex 3 composition to be compatible with certain herbicide compositions and in admixture with neat Flexi-N.

As a result, compatibility tests were then conducted with diluted Flexi-N and with standard CIPAC STD C water. In this study, 20 ml of standard CIPAC STD C water was used in each trial to which the formulation(s) was/were added, following by making up to 100 ml with Flexi-N. The results are summarised in Table 4.

TABLE 4
Compatibility in Standard “Flex-N” liquid fertiliser
containing 20% (v/v) standard CIPAC STD C water

| Formulation(s) | Observation | Comments |
|---|---|---|
| Ex 3 composition | Compatible | Forms an emulsion which showed |
| (5 ml) | with | 1 ml of cream formation after 2 h. |
| CIPAC STD C water | agitation | Re-emulsifies upon re-inversion. |
| (20 ml) | | |
| Flexi-N (75 ml) | | |
| “Round-up Power | Compatible | Forms a clear solution |
| Max” (10 ml) | | |
| CIPAC STD C water | | |
| (20 ml) | | |
| Flexi-N (70 ml) | | |
| Ex 3 composition | Compatible | Forms an emulsion which shows |
| (5 ml) | with | separation with formation of 7 ml |
| “Round-up Power | agitation | of cream. Re-emulsifies upon re- |
| Max” (10 ml) | | inversion. |
| CIPAC STD C water | | |
| (20 ml) | | |
| Flexi-N (65 ml) | | |
| Surpass 300 (6 ml) | In- | Initially a clear solution forms, |
| CIPAC STD C water | compatible | but crystals form after 2 h and |
| (20 ml) | | do not re-dissolve upon re- |
| Flexi-N (74 ml) | | inversion |
| Ex 3 composition | In- | Good emulsion forms initially, but |
| (5 ml) | compatible | 12 ml crystal formation is |
| Surpass 300 (6 ml) | | observed after 2 h. Crystals did |
| CIPAC STD C water | | not re-dissolve upon re-inversion. |
| (20 ml) | | |
| Flexi-N (69 ml) | | |
| Diuron 900 (3 g) | Compatible | Forms good emulsion when |
| CIPAC STD C water | with | suspended in 20 ml of std. CIPAC |
| (20 ml) | agitation | STD C water first. Forms 10 ml of |
| Flexi-N to 100 ml | | solid precipitate after 2 h, but |
| | | re-emulsifies upon re-inversion |
| Ex 3 composition | Compatible | Forms an emulsion initially when |
| (5 ml) | with | Diuron is suspended in water first. |
| Diuron 900 (3 g) | constant | 2 ml of cream and 1 ml of solid |
| CIPAC STD C water | agitation | form on top and bottom |
| (20 ml) | | respectively. Cream re-emulsifies |
| Flexi-N to 100 ml | | upon re-inversion but solid |
| | | needed very vigorous shaking to |
| | | be re-suspended. |

From this study, it is determined that composition of Example 3 is compatible or compatible with agitation when mixed with Power Max, Surpass 300 and Diuron 900 DF in CIPAC STD water C at the rates indicated herein. In addition, Ex 3 composition can be emulsified with agitation in neat Flexi-N and is also compatible with Power Max (at the rate specified) in neat Flexi-N. The composition, Ex 3 composition, is incompatible with either Surpass 300 or Diuron 900 DF in neat “Flexi-N” liquid fertiliser.

When mixed with diluted Flexi-N having 20% standard CIPAC STD C water, Ex 3 composition is compatible in with Power Max, Diuron 900 DF (with constant agitation), but is incompatible with Surpass 300.

### Example 4

### Compatibility Study of 3-Way Mixes

Compatibility studies were performed on Ex 3 composition in combination with various herbicidal formulation(s) in dilute “Flexi-N” liquid fertiliser containing 20% CIPAC STD C water. The results are shown in Table 5.

Flexi-N is a registered Trademark of CSBP.

TABLE 5
Compatibility of 3-way mixes in Standard Flex-N
containing 20% (v/v) standard CIPAC STD C water

| Formulation(s) | Observation | Comments |
|---|---|---|
| Ex 3 composition | Compatible | Forms emulsion initially which |
| (5 ml) | with | separates into 1.5 ml of solid |
| EC, P. Max (5 ml) | agitation | (bottom) and 4 ml oil (top). Re- |
| Diuron 900 (dg) | | emulsifies upon inversion. |
| CIPAC STD C Water | | |
| (20 ml) | | |
| Flexi-N to 100 ml | | |

Three-way mixing experiments show that the Ex 3 composition is compatible with agitation when prepared in Flexi-N diluted with standard water C (20%), with Power Max and Diuron 900 DF.

### Example 5

A herbicidal concentrate was prepared containing a mixture of trifluralin and cinmethylin herbicides in accordance with the following composition:

Example 5 (Ex 5) Composition

(400 g/L Trifluralin + 117 g/L Cinmethylin)

| | | |
|---|---|---|
| Trilfuralin 96% | 417 | g |
| Cinmethylin 96% | 122 | g |
| KEMMAT HF60 | 45 | g |
| TERMUL 1284 | 55 | g |
| Acetophenone | 100 | g |
| SOLVESSO 150 | to 1 | L |

### Example 6

A herbicidal concentrate was prepared containing a mixture of pendimethalin and cinmethylin herbicides in accordance with the following table:

(350 g/L Pendimethalin)

| | | |
|---|---|---|
| Pendimethalin 93.7% | 373.5 | g |
| KEMMAT HF60 | 30 | g |
| TERMUL 1284 | 20 | g |
| TERIC 305 | 60 | g |
| Acetophenone | 200 | g |
| SOLVESSO 150 | to 1 | L |

### Example 7

A herbicidal concentrate may be prepared containing pendimethalin in accordance with the following composition:

(400 g/L Pendimethalin)

| | | |
|---|---|---|
| Pendimethalin 93.7% | 426.9 | g |
| KEMMAT Hf60 | 50-100 | g |
| TERMUL 1284 | 50-100 | g |
| Acetophenone | 100-200 | g |
| SOLVESSO 150 | to 1 | L |

### Example 8

A herbicidal concentrate containing pendimethalin and cinmethylin may be prepared in accordance with the following composition.

(300 g/L Pendimethalin + 100 g/L Cinmethylin)

| | | |
|---|---|---|
| Pendimethalin 93.7% | 320.2 | g |
| Cinmethylin 96% | 104.2 | g |
| KEMMAT HF60 | 50-100 | g |
| TERMUL 1284 | 50-100 | g |
| Acetophenone | 100-200 | g |
| SOLVESSO 150 | to 1 | L |

### Example 9

A herbicidal concentrate containing a mixture of trifluralin and dichlorobenil may be prepared in accordance with the following composition.

(200 g/L Trifluralin + 200 g/L Dichlobenil)

| | | |
|---|---|---|
| Trilfuralin 96% | 208.3 | g |
| Dichlobenil 98% | 204.1 | g |
| KEMMAT HF60 | 50-100 | g |
| TERMUL 1284 | 50-100 | g |
| Acetophenone | 100-250 | g |
| SOLVESSO 150 | to 1 | L |

### Example 10

A herbicidal concentrate containing a mixture of trifluralin and dimethenamid may be prepared in accordance with the following composition:

(200 g/L Trifluralin + 200 g/L Dimethanamid-P)

| | | |
|---|---|---|
| Trifluralin 96% | 208.3 | g |
| Dimethenamid-P 96% | 208.3 | g |
| KEMMAT HF60 | 50-100 | g |
| TERMUL 1284 | 50-100 | g |
| Acetophenone | 100-250 | g |
| SOLVESSO 150 | to 1 | L |

### Examples 11 to 13

These examples compare the solution stability of compositions of the invention which have a carrier containing from 5 to 25% acetophenone (w/w of total composition) and an alkylbenzene of flash point above 60.5° C. (“SOLVESSO” 150).

### Example 11

This example examines stability of trifluralin compositions.

Six 100 ml samples were prepared with acetophenone concentration ranging between 0 and 35 g/L in accordance with the following composition:

| MATERIAL | AMOUNT (g) |
|---|---|
| Trifluralin technical (96%) | 52.08 |
| KEMMAT HF60 | 3.0 |
| TERMUL 1284 | 2.0 |
| TERIC 305 | 6.0 |
| Acetophenone | 0-35.0 |
| SOLVESSO 150 | To 100 ml |

Each of the formulations were placed at 0° C. for 7 days. At the end of 7 day period the samples were evaluated for crystal formation yielding the following results:

| Acetophenone content g/100 ml | Crystals (% volume) |
|---|---|
| 0 | 22.5 |
| 5 | 10.8 |
| 10 | Trace |
| 15 | None |
| 25 | None |
| 35 | None |

It was found that the extent of crystal formation depended on the content of acetophenone in the formulation, with 10 g/L of acetophenone being the optimal concentration of acetophenone.

### Example 12

Similarly, six formulations of 350 g/L pendimethalin were prepared with acetophenone content varying between 0 and 35 g/L. The formulation details were as follows:

| MATERIAL | AMOUNT (g) |
|---|---|
| Pendimethalin technical (93.7%) | 37.35 |
| KEMMAT HF60 | 3.0 |
| TERMUL 1284 | 2.0 |
| TERIC 305 | 6.0 |
| Acetophenone | 0-35.0 |
| SOLVESSO 150 | To 100 ml |

Again, each of the formulations were placed at 0° C. for 7 days. At the end of the 7 day period, the samples were evaluated for crystal formation yielding the following results:

| Acetophenone content g/100 ml | Crystals (% volume) |
|---|---|
| 0 | 9.1 |
| 5 | Trace |
| 10 | Trace |
| 15 | Trace |
| 25 | Trace |
| 35 | 6.6 |

For the above data it can be concluded that initially increasing concentration of acetophenone improves cold stability of this formulation, however, once acetophenone content reaches 35 g/L, cold stability of the resulting formulation is compromised.

### Example 13

Pendimethalin formulations containing 400 g/L of the active were also prepared with varying levels of acetophenone as indicated below:

| MATERIAL | AMOUNT (g) |
|---|---|
| Pendimethalin technical (93.7%) | 42.7 |
| KEMMAT HF60 | 3.0 |
| TERMUL 1284 | 4.0 |
| Acetophenone | 0-35.0 |
| SOLVESSO 150 | To 100 ml |

Following 7 days at 0° C. crystal formation was evaluated with the following results.

| Acetophenone content | Crystals (% volume) |
|---|---|
| 0 | 15.1 |
| 5 | 11.6 |
| 10 | 5.7 |
| 15 | 5.6 |
| 20 | 8.4 |
| 25 | 8.0 |
| 35 | 11.5 |

The use of acetophenone in the 400 g/L pendimethalin formulation, although not as effective in improving the cold stability of the formulation, was found to have an optimal effect when acetophenone is used at a 10-15% w/v level.

The results demonstrate that the use of acetophenone in dinitroaniline formulations improves their cold stability by reducing crystal growth when present in amounts of 5 to 25% preferably 5 to 20% more preferably 5 to 17% and most preferably 8 to 12% by weight of the total composition.

### Example 14

### Trifluralin & Cinmethylin Tank Mixing Procedure

The following describes tank mixing procedure which may be used to mix a trifluralin (formulation A) and cinmethylin (formulation B) compositions together in a standard spray tank from separate drums. The tank mix composition may be used for a broad-acre or similar ground boom spray application.

### Procedure

The boom spray tank is filled to a minimum level of 60-80% full with clean water whilst maintaining continued agitation to ensure thorough mixing of any products added. Whilst continuing to add the remainder of the water volume required to spray the desired area both formulations A & B are added to the tank at the necessary volumes to cover the intended spray area at the desired application rates. Once the required volume of both formulation A and B are added to the tank addition of water is continued to the desired volume for spraying whilst continuing to maintain constant agitation and mixing in the spray tank. Agitation of the spray tank is preferably continued prior to and during the spray operation.

Formulation A

| Name | CAS No. | Proportion |
|---|---|---|
| Trifluralin | 1582-09-08 | 480 g/L |
| Dispersants | n/a | <10% |
| Liquid Hydrocarbon | 64742-94-5 | 499 g/L or 557 g/L |

Formulation B

| Name | CAS No. | Proportion |
|---|---|---|
| Cinmethylin | 89368-00-3 | 73.5% |
| Inerts | n/a | 10% |
| Iso-naphthalene | n/a | 16.5% |

The tank mix composition may be applied to a rate of about 0.6 to 5.0 kg per hectare of trifluralin depending on the conditions and type of weed to be controlled.

### Example 15

This example compares the efficacy of Example 3 composition when applied with “Flexi N” UAN as a carrier with the composition applied with water as the carrier.

A glasshouse efficacy test was conducted to compare the Annual Ryegrass efficacy and wheat crop safety performance of the different trifluralin formulation.

### Application of Compositions:

In Annual Ryegrass (Lolium rigidum) pots 25 seeds were planted to a depth of 1 cm, whilst in wheat (Triticum aestivum) pots 10 seeds per pot were sown to a depth of 4 cm. Pots were of a sandy loam soil and maintained at 10% moisture. Herbicide treatments were applied in an enclosed laboratory track sprayer with a light dusting of 1 mm of soil being applied to each pot after application to simulate a sowing situation. Trifluralin application rates were selected on known dose responses for Annual ryegrass for this particular glasshouse. All trifluralin rates were applied in three carrier solutions—these included Water applied at 72.5 L/ha, Flexi N (neat applied at 72.5 L/ha and Flexi N applied at 72.5 L/ha with water (20%) added to achieve a carrier volume of 87 L/ha. All treatments were applied through a standard flat fan spray nozzle. Annual Ryegrass and Wheat germination was recorded following application.

Result from this glasshouse experiment display a typical dose response for Annual Ryegrass from Trifluralin when applied in water however there is a notable and unexpected benefit in Annual ryegrass weed control when trifluralin was applied in a neat Flexi-N (UAN) liquid solution when compared to water alone as the carrier. However of note in the results is also the unexpected and notable further improvement in weed control performance of Ex 3 composition when applied in the Flexi N plus water 20% v/v.

Results from this trial show an unexpected improvement in weed control from the Example 3 composition formulation when applied in a UAN solution such as Flexi N or a Flexi N plus water solution highlighting the robustness and unexpected stability of the formulation in liquid fertiliser solutions and other possible carrier solutions.

Ryegrass Germination 14DAT (Plants per Pot).

| | | | Flexi N & |
|---|---|---|---|
| | Water | Flexi N | 20% v/v Water |
| | 72.5 L/ha | 72.5 L/ha | (87 L/ha) |
| TriflurX 50gai/ha | 13.0 | 11.2 | 12.8 |
| TriflurX 100gai/ha | 13.0 | 10.2 | 12.7 |
| TriflurX 200gai/ha | 6.2 | 5.8 | 6.2 |
| Ex 3 composition 50gai/ha | 14.3 | 13.7 | 6.2 |
| Ex 3 composition 100gai/ha | 14.0 | 12.0 | 7.8 |
| Ex 3 composition 200gai/ha | 5.5 | 6.2 | 2.5 |

Untreated Pots - 14.5 Ryegrass Plants Germinated

### Example 16

A field trial was conducted at Warrakirri in Victoria Australia with the primary aim of comparing the field performance of Example 3 composition against a commercial 480 gai/L trifluralin formulation when applied at different rates in two carrier types.

Carrier systems evaluated included water at 71.3 L/ha and neat “Easy N” UAN liquid fertiliser solution also applied at 71.3 L/ha. Treatments were applied using good trial techniques that also represent common grower practice and application technique. Herbicide incorporation and sowing method were also consistent with common grower practises.

Results from the trial show a superior performance through increased weed control by the Ex 3 composition product in both carrier types with an unexpected improvement in Ex 3 composition weed control being achieved when applied in a neat UAN solution. Of note is the improvement in Annual Ryegrass weed control performance of Ex 3 composition against the current commercial formulation when applied in neat Easy N (UAN). This trial result confirms superior weed control performance when the combination of Ex 3 composition and Flexi N are used in combination together.

Annual Ryegrass Germination 56-DAT (Plants per square metre).

| | Water | Easy-N |
|---|---|---|
| | 71.3 L/ha | 71.3 L/ha |
| Generic Trifluralin 480gai/ha | 18.68 | 26.68 |
| Generic Trifluralin 960gai/ha | 16.92 | 0.0 |
| Generic Trifluralin 1440gai/ha | 10.28 | 9.32 |
| Ex 3 composition 480gai/ha | 18.68 | 4.0 |
| Ex 3 composition 960gai/ha | 5.32 | 1.32 |
| Ex 3 composition 1440gai/ha | 0.0 | 2.68 |

Untreated Plot: Ryegrass 21.72 plants/m²

### Example 17

Field Trials of Example 5 composition (400 g/L Trifluralin+117 g/L Cinmethlyin—see Example 5) with UAN Compatibiliser.

A series of field trials were conducted throughout Australia to assess the performance of Example 5 composition (400 g/L trifluralin+117 g/L cinmethylin+UAN compatibiliser) versus the performance of either trifluralin or cinmethylin applied as standalone treatments.

All trials were sown under a knifepoint/reduced tillage seeding systems with trial design and management reflecting common district and grower practice. Rates of herbicide application were designed to allow comparison of the co-mixture and solvency package against the relative merits of either active ingredient applied alone in their currently available commercial formulation package (see table below).

Grams active ingredient applied with each formulation

| | Product | | |
|---|---|---|---|
| | Rate Applied | Trifluralin | Cinmethylin |
| | L/ha | gai/ha | gai/ha |
| Trifluralin (480 g/L) | 1.5 | 720 | |
| Trifluralin (480 g/L) | 2.0 | 960 | |
| Trifluralin (480 g/L | 3.0 | 1440 | |
| Cinmethylin (735 g/L) | 100 | | 100 |
| Cinmethylin (735 g/L) | 200 | | 200 |
| Cinmethylin (735 g/L) | 400 | | 400 |
| Ex 5 composition | 0.86 | 344 | 100 |
| Ex 5 composition | 1.8 | 720 | 210 |
| Ex 5 composition | 2.3 | 920 | 269 |
| Ex 5 composition | 3.5 | 1400 | 409 |

Products were applied prior to sowing and were applied in water with industry accepted application equipment and spray nozzles. Result from the trial show a marked increase in Annual Ryegrass weed control by the Example 5 composition formulation over the comparative performance and weed control over either trifluralin or cinmethylin applied alone. Therefore the unexpected ability to mix two active ingredients such as trifluralin and cinmethylin at higher loadings of each in a single formulation provides the opportunity for storage and handling benefits as well as benefits in active loading and subsequent weed control as displayed in the below series of field trials.

| | | Plants/m2 | | | | | | | | |
|---|---|---|---|---|---|---|---|---|---|---|
| | | Vic | Vic | WA | WA | | WA | | | |
| | | Wheat | Lentils | Wheat | Canola | Vic | Lupins | Vic | | |
| | | H03 | H02 | W06-196 | W06-197 | Lentils | W06-200 | Wheat | | |
| | | 79-DAT | 51-DAT | 27-DAT | 27-DAT | 81-DAT | 19-DAT | 49-DAT | | |
| | gai/ha | LOLRI | LOLRI | LOLRI | LOLRI | LOLRI | LOLRI | LOLRI | Mean | % control |
| Trifluralin | 720 | 168 | 21 | 191 | 264 | 26 | 224 | 105 | 143 | 63 |
| Trifluralin | 960 | 22 | 19 | 207 | 208 | 22 | 169 | 10 | 94 | 76 |
| Trifluralin | 1440 | 33 | 14 | 135 | 156 | 23 | 184 | 29 | 82 | 79 |
| Cinmethylin | 100 | 136 | 15 | 300 | 419 | 18 | 503 | 69 | 208 | 46 |
| Cinmethylin | 200 | 78 | 8 | 264 | 307 | 10 | 235 | 67 | 138 | 64 |
| Cinmethylin | 400 | 19 | 10 | 229 | 324 | 14 | 124 | 22 | 106 | 73 |
| Ex 5 composition | T344 + C100 | 77 | 12 | 277 | 228 | 19 | 170 | 45 | 118 | 69 |
| Ex 5 composition | T720 + C210 | 32 | 7 | 109 | 167 | 11 | 111 | 30 | 67 | 83 |
| Ex 5 composition | T920 + C269 | 29 | 9 | 179 | 191 | 15 | 105 | 38 | 81 | 79 |
| Ex 5 composition | T1400 + C409 | 52 | 17 | 100 | 147 | 12 | 99 | 28 | 65 | 83 |

| | | | | | | | | | |
|---|---|---|---|---|---|---|---|---|---|
| UNTREATED CONTROL | 297 | 23 | 494 | 649 | 31 | 1088 | 129 | 387 | 0 |

In the column headed gai/ha for Ex 5 composition the T value is for Trifluralin and the C value is for Cinmethylin
Ex 5 Composition (400 g/L trifluralin + 117 g/L cinmethylin)

Finally, it is understood that various other modifications and/or alterations may be made without departing from the spirit of the present invention as outlined herein.

1. A herbicidal composition comprising:
(i) from about 30 to about 70% by weight of the composition, of at least one dinitroaniline herbicide;
(ii) an organic solvent having a flash point of greater than 60.5° C.; and
(iii) acetophenone in amount in the range of from 5 to 25% by weight.

2. A composition according to claim 1 wherein the composition does not give rise to crystalline precipitates upon storage for at least 48 hours at 0° C.

3. A composition according to claim 1 comprising from about 5 to about 20% by weight of the composition, of acetophenone.

4. A composition according to claim 1 comprising from about 8 to about 17% by weight of the composition, of acetophenone.

5. A composition according to claim 1 comprising from about 35 to about 65% by weight of the composition, of said at least one dinitroaniline and wherein said at least one dinitroaniline is selected from the group consisting of trifluralin, pendimethalin and ethalfluralin.

6. A composition according to claim 5 comprising from about 37 to about 65% by weight of the composition, of trifluralin.

7. A composition according to claim 6 comprising from about 40 to about 65% by weight of the total composition of trifluralin.

8. A composition according to claim 1 wherein the composition further comprises from about 0.5 to about 20% (w/w) of at least one oil-in-water emulsifier adapted to provide an emulsion on dilution of the composition with water.

9. A composition according to claim 8 wherein oil-in-water emulsifier comprises a phosphate ester surfactant.

10. A composition according to claim 9 comprising from about 1 to about 10% (w/w) of a phosphate ester surfactant.

11. A composition according to claim 9 wherein the surfactant includes a phosphorylated alcohol ethoxylate surfactant.

12. A composition according to claim 1 wherein the composition is an emulsifiable concentrate adapted to form an oil-in-water emulsion on dilution with water.

13. A composition according to claim 1 wherein the organic solvent comprises alkyl benzenes.

14. A composition according to claim 1 wherein the solvent component including the co-solvent comprises at least 30% by weight of the solvent component of alkyl benzenes.

15. A composition according to claim 12 wherein the composition is stable when diluted with a liquid fertilizer prior to use.

16. A composition according to claim 15 wherein the composition is diluted prior to use with a liquid fertilizer comprising at least one of UAN and UAS.

17. A method of controlling weeds comprising diluting a dinitroaniline concentrate according to claim 1 and applying the diluted concentrate at a rate of the dinitroaniline component sufficient to provide pre-emergent weed control.

18. A herbicidal composition according to claim 1 further comprising at least one additional herbicide selected from fast knock down herbicides and residual herbicides.

19. A herbicidal composition according to claim 1 comprising one or more additional herbicides selected from the group consisting of amide herbicides; anilide herbicides; arylalanine herbicides; chloroacetanilide herbicides; sulfonanilide herbicides; sulfonamide herbicides, thioamide herbicides, antibiotic herbicides, benzoic acid herbicides; pyrimidinyloxybenzoic; pyrimidinylthiobenzoic acid herbicides; phthalic acid herbicides; picolinic acid herbicides; quinolinecarboxylic acid herbicides; arsenical herbicides; benzoylcyclohexanedione herbicides; benzofuranyl alkylsulfonate herbicides; carbamate herbicides; carbanilate herbicides; cyclohexene oxime herbicides; cyclopropylisoxazole herbicides; dicarboximide herbicides;
dinitrophenol herbicides; diphenyl ether herbicides; nitrophenyl ether herbicides; dithiocarbamate herbicides; halogenated aliphatic herbicides;
imidazolinone herbicides; inorganic herbicides; nitrile herbicides; organophosphorus herbicides; oxadiazolone; phenoxy herbicides; phenoxyacetic herbicides; phenoxybutyric herbicides; phenoxypropionic herbicides; aryloxyphenoxypropionic herbicides; phenylenediamine herbicides; phenyl pyrazolyl ketone herbicides; pyrazolylphenyl herbicides; pyridazine herbicides; pyridazinone herbicides; pyridine herbicides; pyrimidinediamine herbicides; quaternary ammonium herbicides; thiocarbamate herbicides; thiocarbonate herbicides; thiourea herbicides; triazine herbicides; chlorotriazine herbicides; methoxytriazine herbicides; methylthiotriazine herbicides; triazinone herbicides; triazole herbicides; triazolone herbicides; triazolopyrimidine herbicides; uracil herbicides; urea herbicides; phenylurea herbicides; sulfonylurea herbicides including: pyrimidinylsulfonylurea herbicides; triazinylsulfonylurea herbicides; thiadiazolylurea herbicides; and unclassified herbicides selected from the group consisting of KIH-485, acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate endothal, fluoromidine, fluridone, fluorochloridone, flurtamone, fluthiacet, indanofan, methyl isothiocyanate, OCH, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan and tritac.

20. A herbicide composition according to claim 19 wherein the one or more herbicides are selected from the group consisting of diuron, glyphosate, cinmethylin, dimethenamid, 2,4-D, dicamba, DNA herbicides such as trifluralin, ethafluralin and pendimethalin, triallate, metolachlor, metolaclor-S, dimethanamid-p, acetochlor, alachlor, oxyflourfen, carfentrazone-ethyl, EPTC (Eptam), alachlor, MCPA, KIH-485, prodiamine, glufosinate and prosulfocarb.
